(19) United States
(12) Patent Application Publication
(10) Pub. No.: US 2023/0161179 A1
(43) Pub. Date: May 25, 2023

(54) CONTACT LENS COMPRISING A LENTICULAR AND HAVING A PROGRESSIVE ADDITION OPTIC ZONE

(71) Applicant: Ohio State Innovation Foundation, Columbus, OH (US)

(72) Inventors: Thomas William RAASCH, Upper Arlington, OH (US); Melissa D. BAILEY, Westerville, OH (US)

(21) Appl. No.: 17/917,834

(22) PCT Filed: Apr. 8, 2021
(86) PCT No.: PCT/US2021/026409

§ 371 Date: Oct. 7, 2022

Related U.S. Application Data
(60) Provisional application No. 63/007,107, filed on Apr. 8, 2020.

(51) Int. Cl. G02C 7/04

(52) U.S. Cl. CPC G02C 7/043; G02C 7/048; G02C 2202/22

(57) ABSTRACT

Disclosed herein is a contact lens comprising a lenticular in a superior portion of the contact lens wherein the contact lens attaches to an upper eyelid of a wearer by the lenticular interacting with an upper tarsal plate of the upper eyelid of a wearer, said interaction allows the contact lens to translate upwards in downgaze and maintain rotational stability. By having rotational stability and translation, a contact lens having a progressive addition optic zone is provided.

### CROSS-REFERENCE TO RELATED APPLICATION

This application claims priority to and benefit of U.S. Provisional Patent Application No. 63/007,107 filed Apr. 8, 2020, which is fully incorporated by reference and made a part hereof.

### BACKGROUND

The current state-of-the art in rotational stabilization includes back surface toricity (effective for rigid gas-permeable contact lenses), base-down and peri-ballast prism, or Dynamic Stabilization which is a modification of base-down prism. There are patients for whom one or none of the existing designs are sufficient to provide rotational stabilization for a contact lens.

Traditionally, rigid gas permeable (RGP) contact lenses are fitted with a “lid attachment” fit by either using the naturally thicker edge of a minus-shaped RCGP contact lens or by adding minus-carrier lenticular (a thicker edge) to a plus-shaped RGP contact lens. The shape that is used in conventional RGP lenses was probably largely a function of what could be manufactured when lid attachment was first described in the 1970s. With these conventional lens, the thicker edge would be found 360° around the lens periphery. However, the lens does not necessarily need to be that shape in order to achieve lid attachment, and other shapes and designs may provide a better fit that allows the contact lens to translate upwards in downgaze. Translation of the lens in downgaze would allow the use of a true bifocal, distance power in the upper, middle portion of the lens, and near power in the lower portion of the lens. In addition, the lid attachment fit provides rotational stabilization for toric lenses and other applications.

Rotational stability is desired in a contact lens for various and numerous reasons, including an ability to provide differing optical viewing regions at different (vertical) locations of the contact lens. Therefore, what is desired are contact lenses that overcome challenges in the art, some of which are described above.

### SUMMARY

Disclosed and described herein is a contact lens with a lid-attachment fit. The portion that is used for lid attachment (i.e., the lenticular) is placed only at the top (superior) aspect of the contact lens. With modern manufacturing capabilities, any number of shapes can be implemented to achieve the lid attachment fit.

The present disclosure relates to translating bifocal, trifocal, or multi focal contact lenses that work when the cornea is spherical or toric. For rotational stabilization, the contact lenses disclosed herein have an advantage over base-down prism, peri-ballasting, and Dynamic Stabilization in that it uses the interaction between the lenticular aspect described below and the upper eyelid tarsal plate to stabilize the contact lens and may also use the interaction between the base of the prism and the lower eyelid. Interactions between the lens and one or both eyelids provides better stabilization in the lens design disclosed herein. This same contact lens design will also allow for the contact lens to have a translational movement when the patient looks from straight ahead gaze into downgaze. Instead of pushing the base of the prism in the contact lens upwards with the lower eyelid, as much of the prior art attempts to do, this design pulls the contact lens upwards with the superior lenticular aspect. This is because the lenticular aspect allows the contact lens to use a “lid-attached” fit, wherein the lens stays with the upper lid as the patient looks downwards.

By having rotational stability and lid attachment, a contact lens with a progressive addition optic zone is provided. Described herein are optics, and evaluation of the performance of an exemplary progressive addition contact lens optic zones. For example, in some instances a contact lens is described that has approximately 3 mm vertical translation on the cornea as the wearer alternates between straight-ahead viewing for distance viewing and downgaze for near viewing. The translation repositions a different region (e.g., distance viewing, near viewing) of the optic zone (OZ) over the pupil of the eye. In some instances, the distance region of the OZ is centered at the pupil center. With downgaze, the pupil translates down relative to the lens, so that the near viewing region, in the lower part of the OZ, is centered at the center of the pupil. A smooth gradient in optical power connects the distance and near regions.

The description below sets forth details of one or more embodiments of the present disclosure. Other features, objects, and advantages will be apparent from the description and from the claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIGS. 1A and 1B are schematic diagrams providing frontal (FIG. 1A) and a profile view (FIG. 1B) of a bifocal contact lens according to lens designs disclosed herein. FIGS. 1A and 1B show a lenticular comprising a minus-carrier lenticular-like curve located on or proximate the superior edge of the contact lens, and an optical zone of the contact lens that provides a smooth gradient in optical power connects the distance and near regions of the contact lens. The embodiment shown in these figures also comprises an optional base-down prism.

FIGS. 1C and 1D are schematic diagrams providing frontal (FIG. 1C) and a profile view (FIG. 1D) of an alternate bifocal contact lens according to lens designs disclosed herein. FIGS. 1C and 1D show a lenticular 101 comprising a minus-carrier lenticular-like curve located further toward the center of the contact lens away from the superior edge of the contact lens 100, and an optical zone of the contact lens that provides a smooth gradient in optical power connects the distance and near regions of the contact lens. The embodiment shown in these figures also comprises an optional base-down prism.

FIG. 2A (front view) and 2B (profile view) are schematic diagrams of a contact lens showing a “push” and “pull” mechanism associated with a superior lenticular and an inferior prism segment.

FIGS. 3A-3F are profile schematic images of exemplary contact lens having various shaped lenticulars in a superior portion of the contact lens.

FIG. 4A is a profile schematic image of exemplary contact lens having an exemplary anatomically-shaped lenticular in a superior portion of the contact lens

FIG. 4B is a front view of the anatomically-shaped lenticular of FIG. 4A showing width (w) and height (h) dimensions.

FIG. 4C is a front view of a contact lens having an anatomically-shaped lenticular in a superior portion of the contact lens.

FIGS. 5A and 5B are profile images of eyes that illustrate the lid attachment fit of contact lens having a lenticular in the superior portion of the lens as compared with a contact lens that does not have a lenticular.

FIGS. 6A-6J illustrate front views of contact lens having non-limiting examples of lenticulars as disclosed and described herein.

FIG. 7A is a contour plot of surface height of an example of an optical zone.

FIG. 7B shows the spherical power variation of an example of an optical zone that is created by the surface height profile of FIG. 7A.

FIG. 7C shows astigmatism power variation of an example optical zone, with contours at 0.50 D intervals.

FIGS. 8A-8D show several examples of calculated retinal images through the example contact lens design and optical zones described herein.

FIG. 9A is an example image for distance viewing through a 2.5 mm diameter pupil, decentered 0.75 mm horizontally.

FIG. 9B shows the same image as FIG. 9A for a decentered 5.5 mm pupil.

FIG. 10 is an example of a contact lens showing positions of exemplary 8 and 11 mm optic zones.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of embodiments and the Examples included therein and to the Figures and their previous and following description. Indeed, the present disclosure can be embodied in many different forms and should not be construed as limited to the embodiments set forth herein.

Disclosed herein is a contact lens comprising lenticular over an upper (superior) portion of the lens. For example, the lenticular may comprise a rounded, minus-carrier, lenticular-like curve over a central, upper portion of the lens, though other lenticular shapes, designs and locations are contemplated.

The various embodiments of a contact lens disclosed herein comprises a superior-located lenticular design that creates: (1) rotational stability of the contact lens in all gazes, (2) upwards translation, or movement, of the contact lens when the eye is in downward gaze, and (3) a general, centered placement of the contact lens over the cornea and the pupil as needed as the person's gaze changes. By “upwards translation of the contact lens when the eye is in downward gaze” means that the contact lens is held in an upwards position when the patient looks down. The embodiments disclosed and described herein include one or more lenticulars located in a superior portion of the contact lens where the lenticular has any shape that would allow any contact lens (soft, rigid gas permeable, hybrid, etc.) to attach itself to the inside of the upper lid.

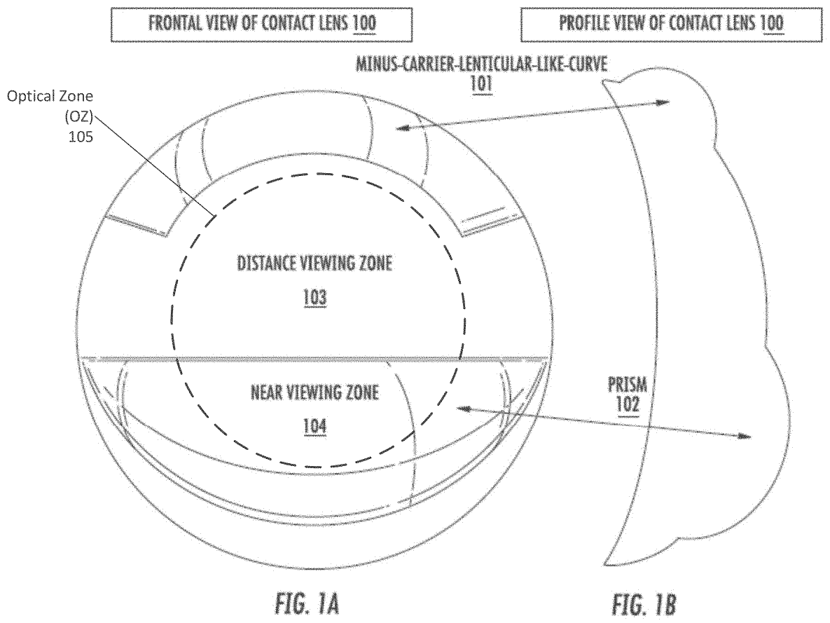

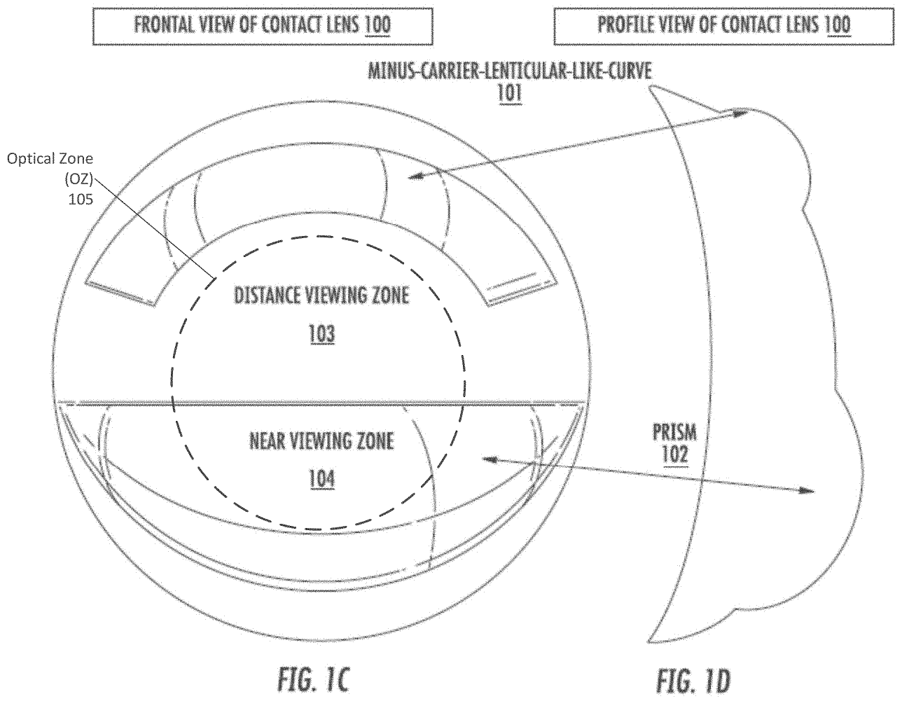

Referring to FIGS. 1A and 1B, a schematic diagram of frontal (FIG. 1A) and profile view (FIG. 1B) of a bifocal contact lens 100 according to lens designs disclosed herein is illustrated. The lens is bifocal in that is has an optical zone 105 comprised of a distance viewing zone 103 and a near viewing zone 104. One of the features of the contact lens shown in FIGS. 1A and 1B is the placement of a lenticular 101 over the upper, central portion of the contact lens. As described herein, the upper portion of the contact lens 100 is referred to as the superior portion and the lower portion of the contact lens 100 is referred to as the inferior portion, Generally the lenticular 101 is located completely in the superior portion of the contact lens 100 above a horizontal midline that passes through the center of the contact lens 100; however, the ends of one or more of the lenticulars may extend into the inferior portion of the contact lens that lies below the horizontal midline. In the embodiment shown in FIGS. 1A and 1B, the lenticular 101 comprises a rounded, minus-carrier-lenticular-like-curve that extends in an arc around a portion of the upper edge of the contact lens 100, though other shapes, sizes and designs of lenticulars 101 are contemplated within the scope of embodiments of this invention and disclosed herein. Another feature of the design shown in FIGS. 1A and 1B is the optional use of a prism 102 or a ballast in the lower portion of the contact lens 100. The combined features of the contact lens 100 disclosed herein provide rotational stabilization, translation, and/or centration. The contact lens disclosed herein can be a rigid gas permeable or soft contact lens design, or a hybrid design, such that the contact lens has a rigid center with soft surround. The lens can be made of a material that can sense light activity or molecules in the ocular environment and that contains elements that modulate light or the surrounding ocular environment, i.e., liquid crystal displays, filters, photochromatic materials, compartments containing other materials, or sensors. Though shown in FIGS. 1A and 1B as bifocal lens, it is to be appreciated that the contact lens 100 described herein can be of any vision including single-vision, bifocal, multifocal, and/or tonic.

FIGS. 1C and 1D are schematic diagrams providing frontal (FIG. 1C) and a profile view (FIG. 1D) of an alternate bifocal contact lens according to lens designs disclosed herein. FIGS. 1C and 1D show a lenticular 101 comprising a minus-carrier lenticular-like curve located further toward the center of the contact lens away from the superior edge of the contact lens 100, and an optical zone 105 of the contact lens that provides a smooth gradient in optical power connects the distance 103 and near 104 regions of the contact lens 100. The embodiment shown in these figures also comprises an optional base-down prism 102.

In FIGS. 1A, 19, 1C, and 1D, the lenticular 101 can be seen at the top of the contact lens 100. The lenticular 101 (in this example a minus-carrier-lenticular-like-curve) can be placed at the upper edge of the contact lens 100, as seen in FIG. 1B, or can be located some distance from the edge of the contact 100, as can be seen in FIG. 1D. For example, the lenticular 101 can be located in the central, upper portion of the contact lens 100. The lenticular 101 can be 0.1, 0.2, 0.3, 0.4, 0.5, 0.6, 0.7, 0.8, 0.9, 1.0, 1.5, 2.0, 2.5, 3.0, 3.5, 4.0, 4.5, or 5.0 millimeters, or more, less, or any amount in-between, away from the outer edge of the contact lens 100. A prism 102 or ballast can be located in the lower half of the contact lens 100. The use of prisms is discussed in more detail herein.

The current state-of-the-art in translating contact lenses is a rigid gas permeable contact lens. There are currently no successful soft contact lenses that achieve translating vision. All of the prior art in translating soft contact lenses moves in the opposite direction of this design, i.e., all other designs attempt to thin the upper portion of the contact lens as much as possible, rather than making it thicker and attached to the upper lid. The contact lens disclosed herein provides a translating contact lens, including a soft contact lens, which is more comfortable and requires less adaptation time than a rigid gas permeable lens. Generally speaking, patients are more willing and able to wear a soft contact lens than a rigid gas permeable contact lens, and a soft contact lens requires less expertise to fit. The current state-of-the-art in bifocal or multifocal soft contact lenses is simultaneous vision. In these lenses, both the rays focusing the distance vision and the rays focusing the near vision are within the pupil at the same time. Thus, the patient must be able to ignore the rays that are not in focus. This leads to some degradation of vision. The translating soft contact lens disclosed herein allow only light from one distance to be in focus at a time, providing clearer vision at each distance.

The other current state-of-the-art option for fitting presbyopic patients in soft contact lenses is called monovision. In this case, one eye is powered for distance vision (usually the dominant eye) and one eye is powered for near vision (usually the non-dominant eye). Some patients are unable to adapt to this type of lens, again, especially when the patient requires a greater reading add power. The difference between the two eyes becomes too uncomfortable. Also, it is well established that monovision correction in contact lenses or laser vision correction leads to a loss of depth perception. The translating soft contact lens disclosed herein allows for the use of higher reading add powers without degradation of the quality of distance vision. Because both eyes are fully and equally corrected at distance and near in the disclosed design, there is no induced loss of depth perception. The translating soft contact lens disclosed herein can also have an optical segment that provides a gradient of power change between the distance and near segments.

The contact lens disclosed herein are designed to suit many practical purposes. For example, in both rigid and soft contact lenses, the lens designs disclosed herein provide rotational stabilization in all gazes for toric contact lens designs, contact lenses designed to correct for various types of ocular aberration beyond a spherical correction, for electronically-generated and/or virtual optically displayed images, and/or bifocal or multifocal contact lenses. Additionally, the lens designs disclosed herein create upwards translation of a bifocal/multifocal contact lens in downward gaze. Furthermore, the lens designs disclosed herein achieve a “lid attached” fit similar to rigid gas permeable contact lens, i.e., keep the contact lens attached under the upper lid before, during, and after a blink.

In one embodiment, the upper portion of the contact lens interacts with an upper eyelid of the wearer. The upper portion of the contact lens that interacts with the upper lid can comprise 5, 10, 15, 20, 25, 30, 35, 40, 45, 50, 55, 60, 65, 70, or 75% of the area between the upper edge of the contact lens and the geometric center of the contact lens. For example, the area of the upper portion of the contact lens (meaning the “top half” of the contact lens, or the area between the upper edge and geometric center of the contact lens) that interacts with the upper lid can comprise 10 to 50% of the upper area of the lens.

Conventionally, a minus carrier lenticular can be used in rigid gas permeable contact lenses in order to create a lid attached fit in a plus-shaped contact lens. In the contact lens design disclosed herein, a lenticular 101 is placed in the central, upper portion of the lens only, rather than over a larger portion of the lens circumference. Some embodiments of the lens designs disclosed herein have a smaller area where a relatively thick edge is present to interact with the upper eyelid margin, and the minimal presence of the lenticular improves comfort over a more traditional minus carrier lenticular that would ordinarily be placed over the entire lens circumference. There is enough surface area and thickness of the lenticular present in the contact lens disclosed herein; however, to interact with the upper tarsal plate to assist with centration and rotational stability.

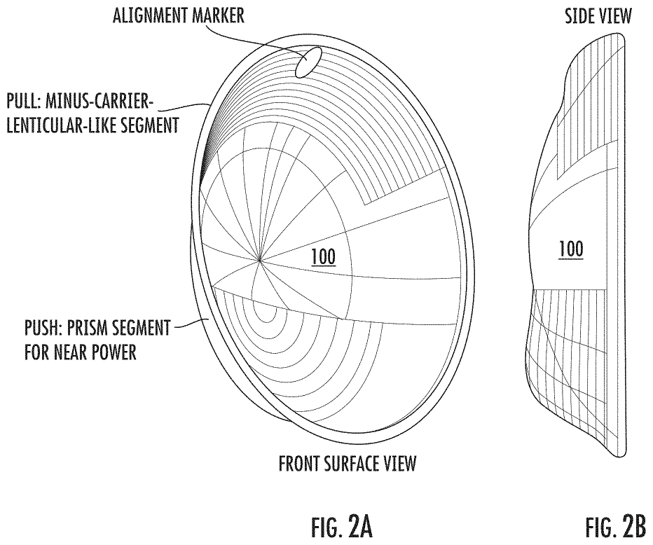

As shown in FIGS. 2A and 2B, and referred to herein as a “push” and a “pull” mechanism, in addition to the upper eyelid interacting with the lenticular, the upper eyelid can also interact with an optional prism in the lower portion of the contact lens according to the lens designs disclosed herein. The edge of the upper eyelid squeezes the thicker, base of the prism of the contact downwards with each blink. The base of the prism also interacts with the lower eyelid with each blink; therefore, the base of the prism is placed above the lower contact lens margin, high enough to remain above the lower eyelid when the eye is open. Just as multiple base curve options are available for fitting different corneal curvatures, multiple heights of the prism base are optionally used to account for differences in aperture size and position of the eyelids. In addition, multiple overall diameters of the contact lens can also be used. In other words, the prism portion can provide a change in power from the central optic zone of the contact lens. The base of the prism may not slide more than 1, 1.5, 2, 2.5, or 3 millimeters (m) behind the lower lid, when in the patient is looking straight ahead and/or downwards when the eye is open and during the blink.

As disclosed above, the contact lens comprises a relatively thick area compared to the remaining portion of the contact lens. This area of thickness can be 1.5, 2, 3, 4, 5, 6, 7, 8, 9, or 10 times thicker than the remaining “non-thick” portion of the contact lens. For example, the relatively thick area can comprise a thickest portion, which is 2 to 10 times thicker than the remaining center portion of the contact lens.

The embodiments of contact lens disclosed herein can be used in the correction of ametropia (myopia, hyperopia, astigmatism, and/or higher order aberrations) in patients with or without presbyopia, i.e., a reading add that moves upwards through translation, in patients with other accommodative disorders, and/or patients with a binocular vision disorder can also be provided in the lens designs disclosed herein. Presbyopia affects approximately 100% of the population who live long enough (˜45 years of age) to develop the condition. The embodiments of contact lens disclosed herein can also treat other accommodative disorders, or binocular vision disorder. In some instances, embodiments of the contact lens disclosed herein can be used to display an electronically-generated and/or other virtual optically-displayed image.

Conventional contact lenses provide very limited options in terms of design parameters such as diameter and curvature. The disclosed contact lenses achieve translation in a soft contact lens. Soft contact lenses are typically only feasible to manufacture in two base curve options, and very few are offered in multiple diameters. These multiple options in these two parameters in addition to the ability to vary the prism height, size, amount, or axis are optionally considered in the lens designs disclosed herein. Back or front surface toricity takes advantage of a toric, rather than spherical, corneal shape that occurs in some patients with astigmatism. The lenses disclosed herein still work when the cornea is spherical (not toric). The described lenses also have an advantage over base-down prism, peri-ballasting, and Dynamic Stabilization in that it optionally uses a lenticular aspect described above to use the upper eyelid tarsal plate to stabilize the contact lens in addition to the prismatic interaction of the lower lid (in lenses having an inferior prism or ballast). Interactions with both lids can provide better stabilization.

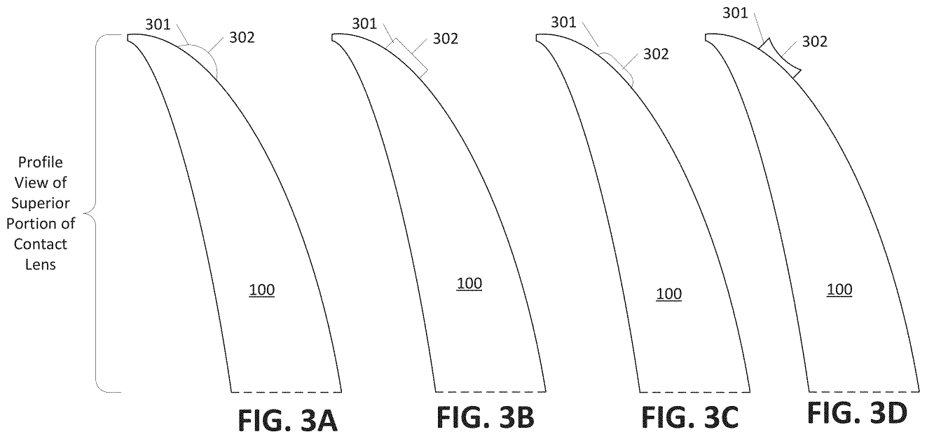

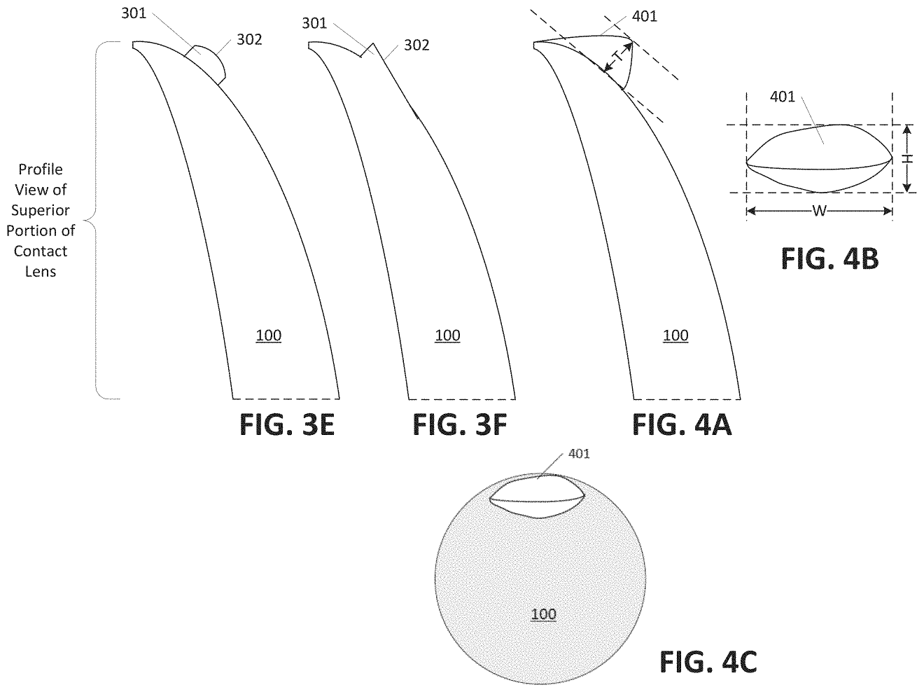

FIGS. 3A-3F are profile schematic images of exemplary contact lens having various shaped lenticulars in a superior portion of the contact lens. Each of the lenticulars 301 have a shaped top surface 302. In FIG. 3A, the lenticular 301 comprises a rounded, minus-carrier, curve 302 over a central, upper portion of the lens. As described herein, the lenticular may be on or proximate to the edge of the contact lens 100, or set back further away from the edge of the lens 100. Further, the lens 100 may include a single lenticular 301, or it can be a plurality of lenficulars having various shapes, sizes and designs. FIGS. 3B-3F illustrate non-limiting examples of profiles of various other lenticulars including a flat-topped 302 lenticular 301 (FIG. 3B), a lenticular 301 having a flat top with rounded edges 302 (i.e., a “bump”) (FIG. 3C), a lenticular 301 having a concave top 302 (FIG. 3D), a lenticular 301 having a convex top 302 (FIG. 3E), and a lenticular 301 having a tapered top 302 shape that is thicker closer to the edge of the contact lens and which gradually thins toward the center of the contact lens (FIG. 3F). It is to be appreciated that the lenticulars 301 shown in FIGS. 3A-3F are intended to be non-limiting and are for exemplary purposes only. It is contemplated that the lenticulars of this invention are not limited by shape, size, number, position, or location (so long as they are substantially located within the superior portion of the contact lens).

FIG. 4A is a profile schematic image of exemplary contact lens having an exemplary anatomically-shaped lenticular in a superior portion of the contact lens. In this embodiment, the lenticular is shaped specifically to fit into a conjunctival sac and attach to the upper eyelid of the wearer. For example, the lenticular of FIG. 4A is designed to fit within Kessing's Space of the wearer's upper eyelid (see, Kessing, Svend V., “A New Division of the Conjunctiva on the Basis of X-Ray Examination,” Acta. Ophthalmologica Vol. 45, 1967, which is fully incorporated by reference.) FIG. 4B is a front view of the anatomically-shaped lenticular 401 of FIG. 4A showing width (w) and height (h) dimensions. In one of the embodiments, the anatomically-shaped lenticular 401 shown in FIGS. 4A and 4B is shaped and sized in accordance with the conjunctival inserts disclosed and described in U.S. Pat. No. 6,217,896, which is fully incorporated by reference.

Although volumetric and linear dimensions vary between individuals, human inferior conjunctival sacs have certain generally common features: a crescent shape horizontally; a thick inferior horizontal ridge and a wedge-like shape sagittally). In order to maximally utilize the actual volume and shape that could be contained in human conjunctival sacs, the anatomically-shaped lenticular 401 can be of a crescent shape in the horizontal plane, with the central back curvature conforming to the bulbar surface (radius of back curvature approximately 14 mm, range 12-18 mm). Most of the volume of the device is contained in the inferior 50% of the shape, within a horizontal ridge situated approximately ⅔ of the way from the top of the lenticular 401 and ⅓ of the way from the bottom of the lenticular 401. The maximum thickness of this ridge, being of a crescent shape in the horizontal plane, is a dimension noted in the table (Table I), below. The front surface of the lenticular 401 is more curved than the back in order to attain the crescent shape. The lenticular 401 tapers superiorly above the ridge, so as to situate between the tarsal plate and the globe, so that the anatomically-shaped lenticular 401 thins to an acute angle at its superior edge. Therefore, in the sagittal plane the lenticular 401 appears wedge-like above the ridge, such that pressure of the inferior margin of the upper eyelid will induce a “minus-carrier” effect and help to contain the lenticular 401 inside inferior cul-de sac. From the middle of the thicker volume in the ridge, the lenticular 401 tapers to blunt points nasally and temporally, such that the lenticular 401 is anchored within the tissue more tightly bound at the canthi. The horizontal length of the lenticular 401 is a dimension, covered in Table Which is measured along the back surface of the lenticular 401 from left to right behind the ridge. At the bottom, the lenticular is rounded from left to right (radius of curvature approximately 22 mm, range 20-25 mm) and from front to back (radius of curvature approximately 0.75 min, range 0.5-1.0 mm in the middle) with the most inferior portion of the lenticular 401 at the horizontal middle.

Below, Table I provides exemplary dimensions for three sizes of an anatomically-shaped lenticular 401 (refer to FIGS. 4A and 4B).

TABLE I
DIMENSIONS OF THREE DESIGNS OF AN
ANATOMICALLY-SHAPED LENTICULAR

| | Three Designs by Size | | |
|---|---|---|---|
| DIMENSIONS | LARGE | MEDIUM | SMALL |
| Volume (μl) | 160 | 110 | 60 |
| Max. Horizontal | 26.75 | 23.5 | 20.25 |
| Width (W) (mm) | | | |
| Max Vertical | 9.0 | 7.9 | 6.8 |
| Height (H) (mm) | | | |
| Max. Thickness | 2.6 | 1.7 | 0.8 |
| (T) (mm) | | | |

From the thickest sagittal plane at its horizontal midpoint, the anatomically-shaped lenticular 401 to the right has a shape of equal, but opposite, conformation to that existing on the left. This is so that the anatomically-shaped lenticular 401 will be wearable in the cul-de-sac of either eye, the left/right shape difference between conjunctival sacs of the two eyes having been shown to be minimal. The vertical height of the insert (or thickness, T) (see FIG. 4A), another dimension noted in Table I, is maximum at the center of the insert and decreases left and right to the blunt lateral extremities. This is because the anatomically-shaped lenticular 401 is somewhat meniscus-shaped in the facial plane, being more convex at its inferior edge and relatively flat horizontally at the superior edge. FIG. 4C is a front view of a contact lens 100 having an anatomically-shaped lenticular 401 in a superior portion of the contact lens.

Additional non-limiting examples of anatomically-shaped lenticulars includes lenticulars having shapes that include round/oval, ellipse, triangular, heart shaped, square, pentagonal, diamond, pear shaped, rectangular, combinations thereof, and the like such that the lenticular is shaped to fit into a conjunctival sac and attach to the upper eyelid of the wearer.

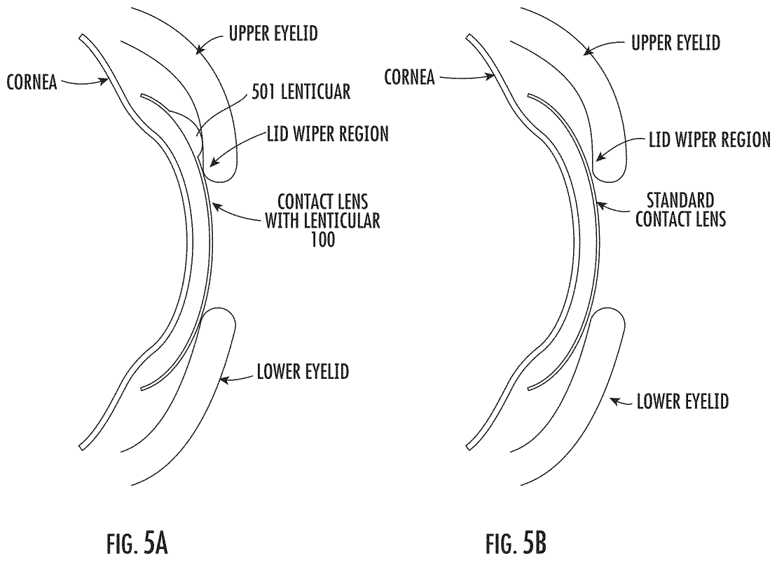

FIGS. 5A and 5B are profile images of eyes that illustrate the lid attachment fit of contact lens 100 having a lenticular 501 in the superior portion of the lens as compared with a contact lens that does not have a lenticular. In various embodiments, the lenticular 501 may be anatomically-shaped to attach to the upper eyelid by fitting within a conjunctival sac.

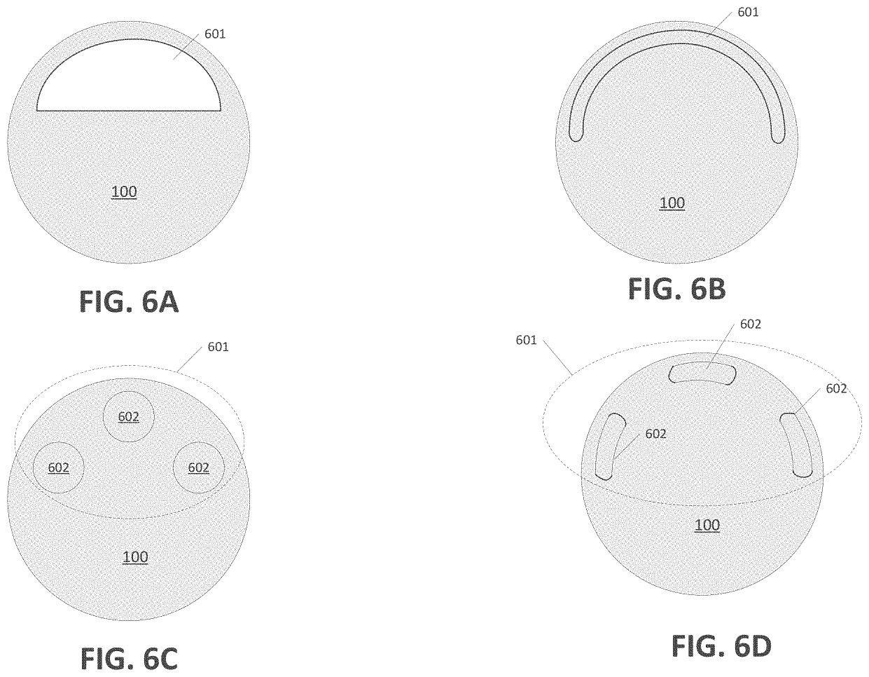

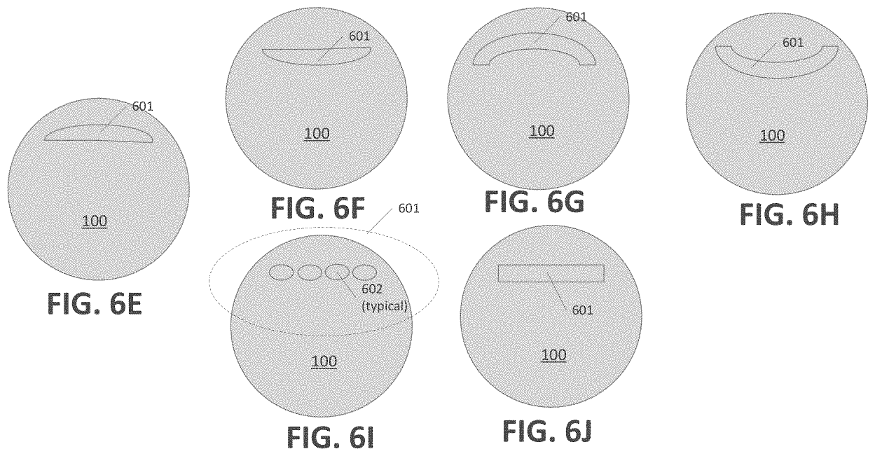

FIGS. 6A-6J illustrate front views of contact lens having non-limiting examples of lenticulars in the superior portion of the contact lens as disclosed and described herein. It is to be appreciated that the lenticular regions of the embodiments shown in FIGS. 6A-6J have at least a portion of the lenticular where the thickness of the lenticular is greater than the thickness of the lens at its center portion. In FIG. 6A, the lenticular 601 has a semicircular shape. In FIG. 6B, the lenticular 601 has an arc shape. It is to be appreciated that the arc length can be shorter or longer that the length shown in FIG. 6B. In FIGS. 6C and 6D, the lenticular 601 is comprised of a plurality of lenticular sections 602. For example, the lenticular 601 of FIG. 6C is comprised of a plurality of semispherical sections on the superior portion of the contact lens and the lenticular 601 of FIG. 6D is comprised of a plurality of arc sections. It is to be appreciated that the multi-section lenticulars of FIGS. 6C and 6D are exemplary and that other numbers of sections, shapes and sizes of lenticulars are contemplated within the scope of embodiments of the invention. FIGS. 6E-6J illustrate non-limiting examples of other shapes, sizes, positions and locations of lenticulars 601 that are contemplated within the scope of embodiments of the invention. Each of the embodiments shown herein may have, or may not have, prisms and/or ballasts in the inferior portion of the contact lens 100.

Also disclosed herein are methods of making the contact lenses disclosed herein. For example, disclosed is a method of making a contact lens, the method comprising manufacturing a contact lens comprising forming a lenticular in the superior portion of the lens. The contact lens can further comprise a base down prism or a ballast in the inferior portion of the lens. In one example, the base down prism or ballast is added to the lens in a second step of a manufacturing process.

Also disclosed is a method of treating an individual in need of vision correction, the method comprising dispensing the contact lens disclosed herein to the individual, thereby treating the individual in need of vision correction. In one example, the individual has been diagnosed with ametropia (e.g., astigmatism, myopia, hyperopia). In another example, the individual has been diagnosed with presbyopia, another accommodative disorder, and/or a binocular vision disorder. For example, one or more surfaces of embodiment of the contact lens described herein can be made tonic (to treat astigmatism), and/or a flatter or a steeper front surface can be formed in the embodiments of contact lens described herein (to correct either myopia or hyperopia), and/or a bifocal/trifocal/multifocal change in power can be formed in the bottom (inferior portion) of the lens to treat presbyopia. Additional medical use of embodiments of the contact lens described herein include treatment of Keratoconus.

Furthermore, embodiments of the disclosed contact lens can be used for cosmetic purposes such as changing/enhancing eye color and/or eye appearance.

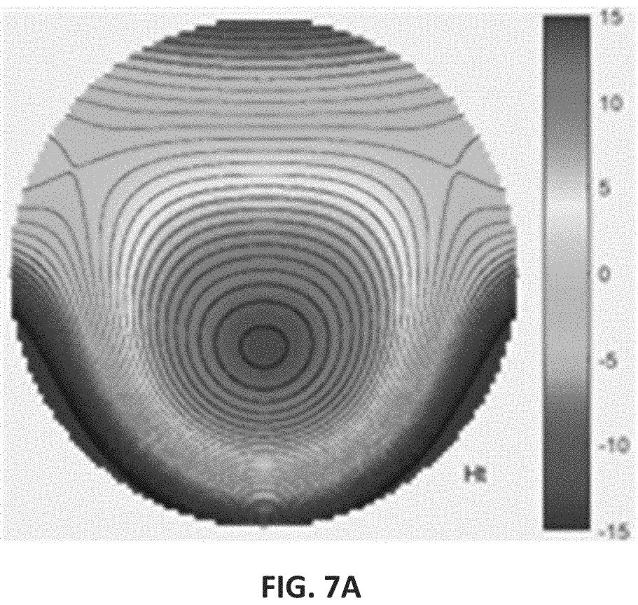

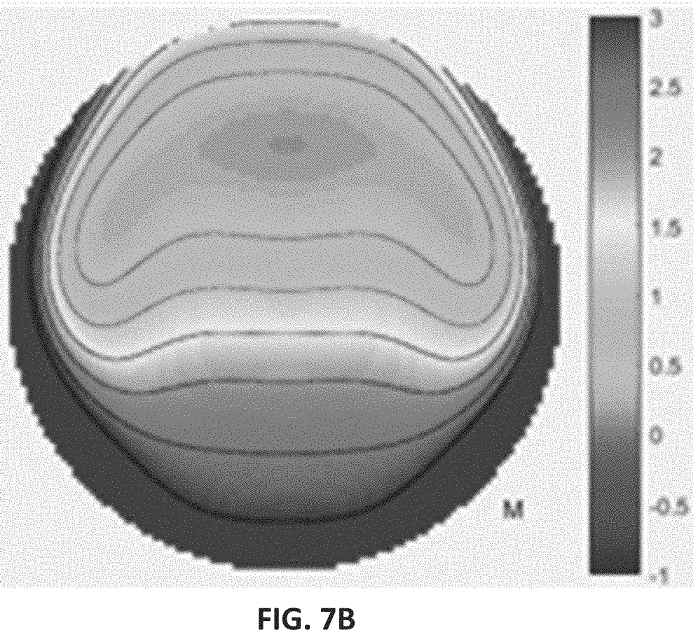

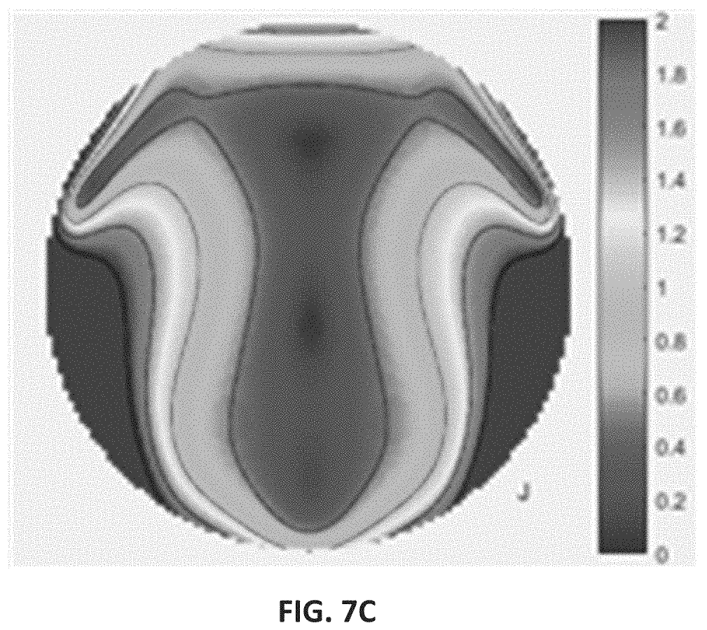

Referring back to the optical zone 105 first described in relation to FIGS. 1A-1D, one version of the optic zone 105 design is illustrated below in FIG. 7A. In FIGS. 7A-7C, the particular optic zone 105 is approximately 8 mm in diameter, although smaller or larger optic zones 105 are equally possible. An 8 mm OZ is large enough to fully surround a 5 mm diameter pupil that for distance is positioned approximately 1.5 mm above the center of the OZ, and for near vision is centered approximately 1.5 mm below the center of the OZ. This optic zone center is 1.5 mm below the center of the full lens, which places the distance region of the OZ at the center of the lens.

FIG. 7A is a contour plot of surface height of the optical zone 105. These surface heights are described mathematically as the weighted sum of Zernike modes. This contour plot of FIG. 7A shows the deviations of the surface above and below the overall convex shape of the front surface of the lens. In FIG. 7A, contour lines are at 2 μm intervals, and span a range of ±15 μm from the baseline convex surface.

FIG. 7B shows the spherical power variation of the OZ 105 that is created by the surface height profile of FIG. 7A. In this example, the upper and lower regions, for distance 103 and near 104 viewing, respectively, have powers of 0.00 D and +2.00 D, i.e. a +2.00 D addition, or “add”. Adjustments to create higher or lower adds are made with adjustments to the Zernike coefficients. In FIG. 7B, contour lines are at 0.50 D intervals. The even spacing of these contour lines through the transition zone indicate the relatively smooth gradient in power from distance to near. Many power combinations are possible here. Sphere powers from ±20.001) and Add powers from 0.25 to as much as ±4.00 D. In some instances, the spherical power variation of the OX 105 that is created by the surface height profile can be combined with cylinder to correct for astigmatism (along with Sphere and the Add).

FIG. 7C shows the astigmatism, with contours at 0.50 D intervals. As with any progressive power lens, minimizing this astigmatism is a design challenge. Higher order aberrations are also inevitably present, but the effect of those aberrations are typically much smaller than the effect of the unwanted astigmatism, particularly for normally-sized pupils. In the disclosed embodiments, the unwanted astigmatism can be near zero (if that level is wanted) along the vertical midline, indicating that a lens that is well-centered horizontally will produce a good quality image on the retina. Evaluating and maximizing retinal image quality is a primary aim of any OZ design, as well as evaluating the effects of lens movement and positioning on the resulting retinal image quality, as described below.

Considering the sphere power plot (FIG. 7B), the spherical power will be between 0.0 D and +0.5 D as long as the pupil center is within the enclosed contour in the upper ⅓^{rd} of the panel. Likewise, considering the astigmatism plot (FIG. 7C), the magnitude of unwanted astigmatism will be below 0.5 D as long as the pupil center is within the contour enclosing the blue region.

The gradient in spherical power has similarities to, and differences from, the power gradient of a progressive addition spectacle lens. In this contact lens design, the spherical power gradient is achieved over a range of approximately 3 mm, while in a spectacle lens, a similar power range is achieved over a 12 to 25 mm range. The steeper gradient in the contact lens. While maintaining good optics within the OX 105, is a more difficult design challenge compared to that imposed by the shallower power gradient in the spectacle lens. Another difference between spectacle and contact lens designs is along the horizontal dimension of the lens. With a spectacle lens, the eye can move freely behind the lens, so acceptable optical quality must be maintained across a wider horizontal range. That is accomplished with some compromise in the maximum quality of the optics throughout that range. In contrast, the contact lens moves horizontally with the cornea, so there is much less horizontal displacement of the lens relative to the pupil. That allows a design strategy that concentrates the highest optical quality along the vertical midline of the OX 105. In addition, the steeper gradient in spherical power in the vertical dimension leads to a steeper gradient in astigmatic power in the horizontal dimension. That differentiates a progressive power spectacle lens from this progressive power contact lens: the spectacle lens distributes the astigmatic power gradient over a greater distance horizontally, requiring some compromise in optical quality throughout. The contact lens design enables the concentration of maximum optical quality along the vertical midline of the OZ.

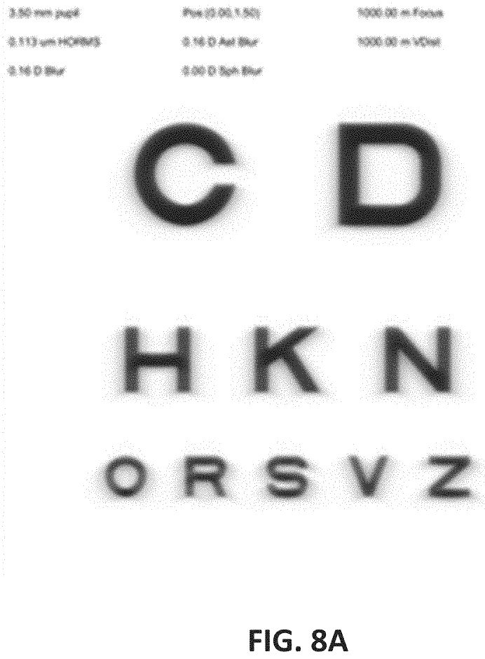

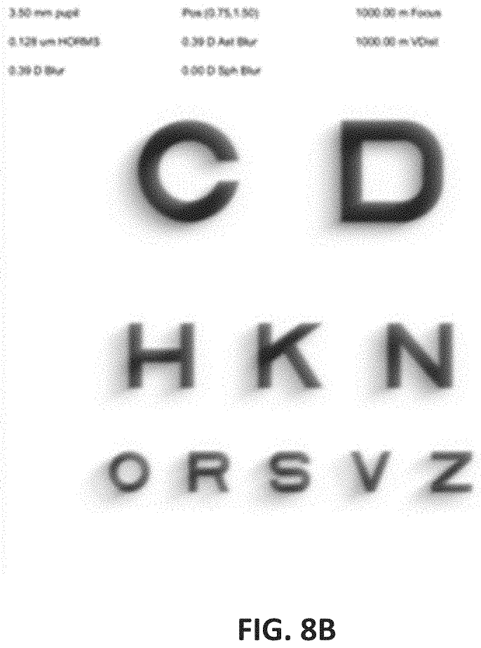

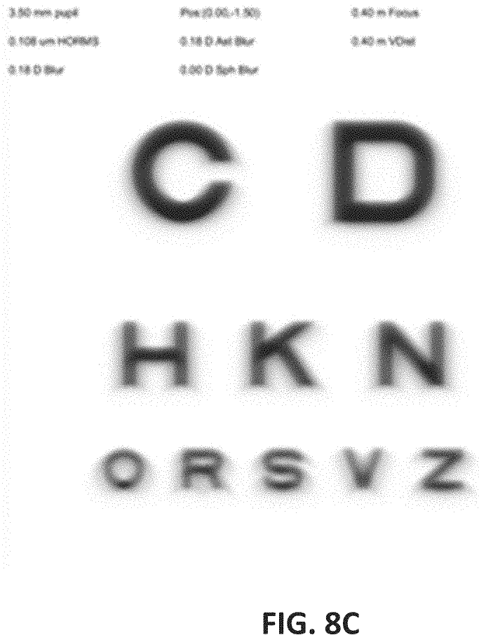

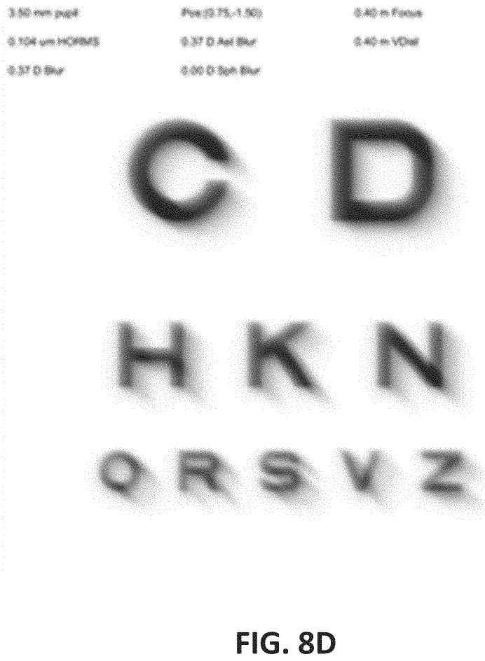

FIGS. 8A-8D show several examples of calculated retinal images through the example contact lens design and optical zones described herein. Angular letter sizes are equivalent to Snellen acuity fractions of 20/50, 20/32, and 20/20. FIG. 8A shows letters at a distance, as imaged through a 3.5 mm diameter pupil. The lens is well-positioned horizontally and vertically. FIG. 8A shows the same image as FIG. 8A for the lens decentered 0.75 mm horizontally. FIGS. 8C and 8D show the counterpart images for letters at a 40 cm distance through the near 104 viewing region of the OZ 105. To reveal the full effect of decentration, any residual spherical blur is nulled by residual accommodation of the wearer. These images show that decentration has a modest effect on image quality. The effect is modest because the pupil center is still within a low-astigmatism and low-aberration region of the OZ 105.

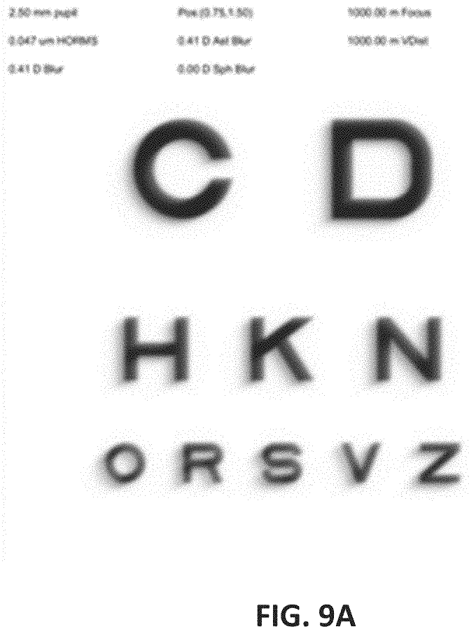

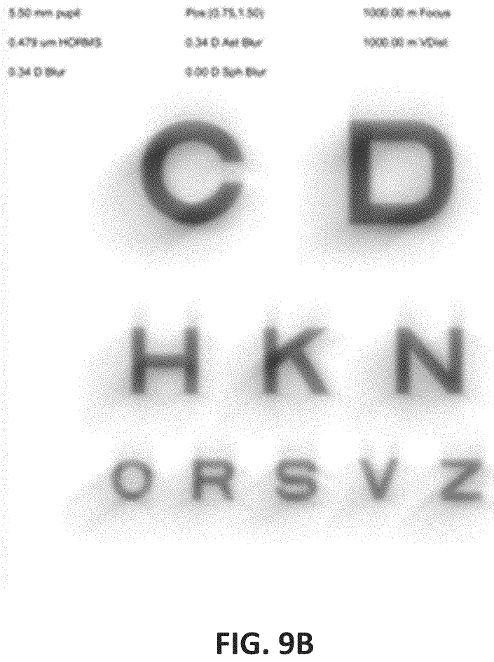

Another factor that can affect retinal image quality is pupil size. In general, the smaller the pupil, the better the retinal image (limited by diffraction with very small pupils). Calculated retinal images similar to those shown in FIGS. 8A-8D show that images for small pupils are somewhat better than for large pupils. A pair of example images are shown in FIGS. 9A and 9B. FIG. 9A is an example image for distance viewing through a 2.5 mm diameter pupil, decentered 0.75 mm horizontally. FIG. 9B shows the same image as FIG. 9A for a decentered 5.5 mm pupil, i.e. the “worst case” scenario—a large pupil with lens decentration. While letter edges remain fairly well focused, there is some loss of contrast, and a bit more “smearing” of the letters.

All lens designs exhibit a similar degradation in retinal image quality with very large pupils, and all show image degradation with larger amounts of horizontal lens decentration. Several lens design variations were created and evaluated. The one used to generate the images shown in these figures are for one of those lens designs, which has a good balance between image quality for distance and for near, with good tolerance for modest amounts of decentration.

Calculation. of spherical and astigmatic powers, and of high-order aberrations, starts with the Zernike description of the full OZ surface. The pupil of the eye, when viewing through a particular location in that OZ, encircles a sub-region of the surface. The Zernike coefficients for that sub-region are calculated by the method described in Raasch, T. Aberrations and spherocylindrical powers within subapertures of freeform surfaces. J. Opt. Soc. Am. A 28, 2642-2646 (2011), which is fully incorporated by reference and made a part hereof, and is also attached hereto as Appendix A. From those coefficients, surface curvatures (and from those, the optical powers) are generated by finding the partial 2^{nd} derivatives of the surface height. The high-order aberrations are also derived from the Zernike coefficients in a similar manner.

The simulated retinal images are generated from the derived powers and aberrations, first by finding the point spread function (PSF) for a pupil of a particular size and location within the OZ. The PSF can be thought of as the fundamental blur of a single point created by a particular lens surface shape. The source (unblurred) image is then blurred by (i.e. convolved with) that PSF to generate the simulated retinal image.

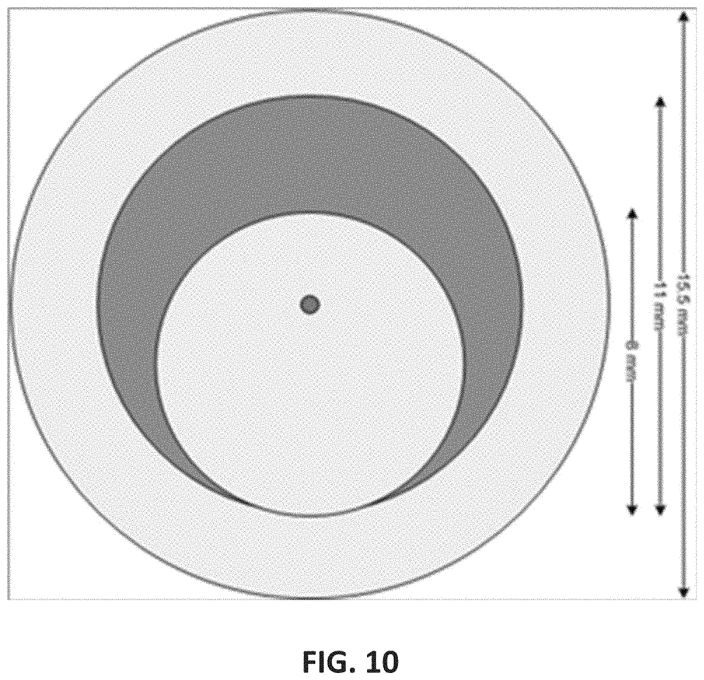

The images shown in FIGS. 7A-7C are for an 8 mm diameter optic zone that is decentered down 1.5 mm from the center of the lens. In FIG. 10, this OZ corresponds with the smaller circle, which is centered 1.5 mm below the lens center. These surfaces are defined using Zernike terms which, by definition, are within a “unit circle”, i.e. a circular region with unit radius and a center at location (x,y)=(0,0). For fabrication, it is necessary to define an OZ that is centered at the lens center. To do that, the OZ was expanded from 8 to 11 mm diameter, and moved up 1.5 mm so that its center coincides with the lens center, as shown in FIG. 10. The bottom boundary of the 8 and 11 mm OZs coincide, and the top boundaries are 3 mm apart.

This involves a transformation of the Zernike coefficients, which become altered both by the expanded size and the shifted position. This transformation maintains the exact surface profile and optical power within the original 8 mm OZ. An additional consequence of this OZ position shift and expansion, however, is that the surface heights, slopes and optical powers outside the original 8 mm OZ (but within the 11 mm OZ) become large enough to create fabrication difficulties. This region is the gray-shaded region in FIG. 10.

To address that issue, a “blending” procedure is used. The blending occurs in the gray-shaded region of the figure. The goal of the blending is to join the surface height at the boundary of the 8 mm OZ with the height of the base lens surface at the boundary of the 11 mm OZ. This process connects those boundaries with a smooth curve, and eliminates the sharp transitions in height, slope and power that would otherwise occur across that region.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit, Other embodiments will be apparent to those skilled in the art from consideration of the specification and practice disclosed herein. It is intended that the specification and examples be considered as exemplary only, with a true scope and spirit being indicated by the following claims.

1. A contact lens comprising:
a superior portion of the contact lens;
an inferior portion of the contact lens;
a progressive addition optical zone; and
a lenticular located in the superior portion of the contact lens, wherein the contact lens attaches to an upper eyelid of a wearer by the lenticular interacting with an upper tarsal plate of the upper eyelid of a wearer, said interaction allows the contact lens to translate upwards in downgaze, and
wherein Zernike coefficients are developed for the optical zone, and said Zernike coefficients are used to determine surface curvatures, spherical powers, and astigmatic powers of the optical zone.

2. The contact lens of claim 1, wherein the optical zone has a diameter of approximately 8 mm.

3. The contact lens of claim 1, wherein the optical zone has a diameter of greater than approximately 8 mm, or wherein the optical zone has a diameter of less than approximately 8 mm.

4. (canceled)

5. The contact lens of claim 1, wherein the optical zone comprises a distance-viewing region and a near-viewing region.

6. The contact lens of claim 5, wherein the distance-viewing region and the near-viewing region, respectively, have spherical powers of 0.00 D and +2.00 D (i.e. a +2.00 D addition, or “add”).

7. The contact lens of claim 6, wherein adjustments to create higher or lower adds are made with adjustments to the Zernike coefficients.

8. The contact lens of claim 5, wherein the optical zone has a relatively smooth transition of spherical powers from the distance-viewing region to the near-viewing region.

9. The contact lens of claim 1, wherein the surface curvatures are described as a weighted sum of Zernike modes.

10. The contact lens of claim 1, wherein any unwanted astigmatism power is near zero along a vertical midline of the contact lens.

11. The contact lens of claim 1, wherein the Zernike coefficients of the optical zone define surface heights of the optical zone, and partial 2nd derivatives of the Zernike coefficients for the surface heights are used to determine the surface curvature, the spherical powers, and the astigmatic powers of the optical zone.

12. The contact lens of claim 1, wherein the lens is a soft contact lens, a rigid gas permeable contact lens, or a hybrid contact lens.

13. (canceled)

14. (canceled)

15. The contact lens of claim 1, wherein the lens is comprised of a material that can sense light activity or molecules in the ocular environment and that contains elements that modulate light or the surrounding ocular environment.

16. The contact lens of claim 1, wherein the lenticular interacting with the upper tarsal plate of the upper eyelid of a wearer comprises the lenticular interacting with the upper tarsal plate of the upper eyelid of a wearer to provide centration and rotational stability.

17. (canceled)

18. The contact lens of claim 1, wherein the lenticular comprises a relatively thick edge of the contact lens in the superior portion of the contact lens that interacts with a margin of the upper eyelid.

19. (canceled)

20. The contact lens of claim 1, wherein the contact lens comprises a base down prism located at least partially in the inferior portion of the contact lens.

21. (canceled)

22. (canceled)

23. (canceled)

24. (canceled)

25. (canceled)

26. The contact lens of claim 1, wherein the contact lens is used to treat ametropia.

27. The contact lens of claim 1, wherein the contact lens is used to treat presbyopia, other accommodative disorders, or a binocular vision disorder.

28. (canceled)

29. (canceled)

30. The contact lens of claim 1, wherein the lenticular is comprised of a plurality of lenticular sections located in the superior portion of the contact lens.

31. The contact lens of claim 1, wherein the lenticular is anatomically-shaped.

32. The contact lens of claim 31, wherein the anatomical shape of the lenticular is designed to fit within Kessing's Space of the wearer's upper eyelid.
